(19) United States
(12) Patent Application Publication
(10) Pub. No.: US 2007/0212998 A1
(43) Pub. Date: Sep. 13, 2007

(54) High speed coin processing machine having multiple coin processing devices

(76) Inventor: Gregory F. String, Mechanicsburg, PA (US)

Correspondence Address: Jeffrey S. Habib, Esq.;Hooker & Habib, P.C., Suite 304, 100 Chestnut St, Harrisburg, PA, 17101, US

(21) Appl. No.: 11/372,422

(22) Filed: Mar. 9, 2006

(51) Int. Cl. G07D 1/00; G07D 9/00; G07D 9/04

(52) U.S. Cl. 453/57; 453/58

(57) ABSTRACT

A coin machine for sorting or verifying coins includes a hopper for receiving and discharging coins and at least two coin processing devices positioned around the hopper. The hopper discharges a separate stream of coins to each coin processing device so that the coin processing devices operate in parallel to sort or verify coins.

### FIELD OF THE INVENTION

The invention relates generally to devices for processing mixed denominations of coins, that is, devices for sorting or verifying coins.

### BACKGROUND OF THE INVENTION

Banks and other business handle mixed denominations of coins. The coins must be sorted by denomination, and the sorted coins are wrapped or bundled for deposit or later use in cash registers or change machines.

Coin processing machines, such as coin sorters and coin verifiers, have been developed to mechanically process mixed denominations of coins. Coin sorters sort the coins. Coin verifiers verify that sorted coins are made up of only coins of a single denomination. Coin verifiers are often used prior to wrapping or bundling coins discharged from a coin sorter.

My pending U.S. patent application Ser. No. 11/249,067 “High Speed Coin Processing Machine”, filed Jan. 11, 2005 and incorporated by reference as if fully set forth herein, discloses a high-speed coin processing machine. The machine disclosed in the '067 application drives coins from a hopper to a processing device on one side of the hopper. An endless belt drives coins released from the hopper to the processing device.

Although my high-speed coin processing machine performs reliably to process coins at high speed, it is always desirable to modify the machine to process coins even more efficiently.

### SUMMARY OF THE INVENTION

The invention is directed to an improved coin processing machine having a number of coin processing devices that operate in parallel to process coins. In one particularly advantageous embodiment, the coin processing machine is of the type disclosed in my '067 application.

A coin processing machine in accordance with the present invention includes a coin feed that supplies at least two streams of coins to respective coin processing devices. The coin processing devices operate in parallel to process coins more efficiently than conventional coin processing machines that employ only a single coin processing device.

In a preferred embodiment of the invention a plurality of belt drives are spaced around the periphery of a turntable that drives coins received from a hopper against an outer peripheral wall. The wall includes a number of discharge openings. Each belt drive is adjacent a respective discharge opening and receives the stream of coins discharged from the opening. The belt drive drives the coins to a respective coin processing device.

The belt drives operate independently of one another and enable coins to be simultaneously fed to multiple coin processing devices to be processed in parallel. Parallel processing improves efficiency of the machine while retaining all the benefits of the single-drive machine disclosed in my '067 application without increasing the speed or size of the turntable.

In one embodiment of the invention the belt drives are located on opposite sides of the hopper. One belt drive feeds coins in a first, clockwise direction to a first coin processing device and the other belt drive feeds coins in a second, counterclockwise direction to a second coin processing device.

Other objects and features of the present invention will become apparent as the description proceeds, especially when taken in conjunction with the accompanying two drawing sheets illustrating one embodiment of the invention.

### BRIEF DESCRIPTION OF THE DRAWINGS

FIG. 1 is a top view of a coin processing machine in accordance with the present invention; and

FIG. 2 is a view of the processing plate and sensor arrays used in the coin processing machine shown in FIG. 1.

### DESCRIPTION OF THE PREFERRED EMBODIMENT

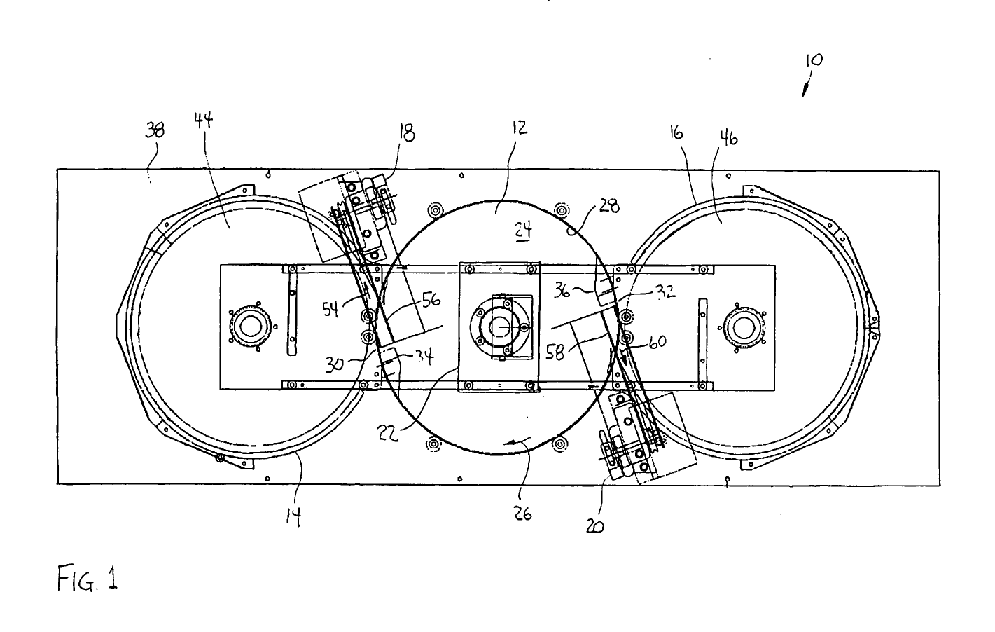

FIG. 1 illustrates a high-speed coin processing machine 10 in accordance with the present invention. The machine 10 includes a hopper 12 for receiving coins to be processed. The hopper 12 discharges two streams of coins for processing by two coin processing devices 14 and 16 located on opposite sides of the hopper 12. A belt drive 18 drives the first stream of coins to coin processing device 14 and a similar belt drive 20 drives the second stream of coins to coin processing device 16.

Hopper 12 has an inlet 22 that deposits coins on a turntable or rotatable disk 24 forming the floor of the hopper 12. The disk 24 is driven in the direction of arrow 26 by an electric motor (not shown). A stationary outer wall 28 extends along the outer periphery of the disk 24 and includes two diametrically-opposite openings 30, 32 where coins are discharged from the hopper. Coins on the disk 24 are urged by centrifugal force against the wall 28 and move along the wall in the direction of disk rotation to be discharged from openings 30, 32.

A singulating plate 34 mounted on the wall 28 extends over the disk 24 at hopper discharge 30 and a similar singulating plate 36 is mounted on wall 28 at hopper discharge 32. Plates 34, 36 are spaced above the disk 24 by a distance less than twice the thickness of the thinnest coin to be processed (a dime if processing US currency). A single-layer stream of coins is discharged from beneath each singulating plate 34, 36 at respective hopper discharges 30, 32 in a direction substantially tangential to the disk 24.

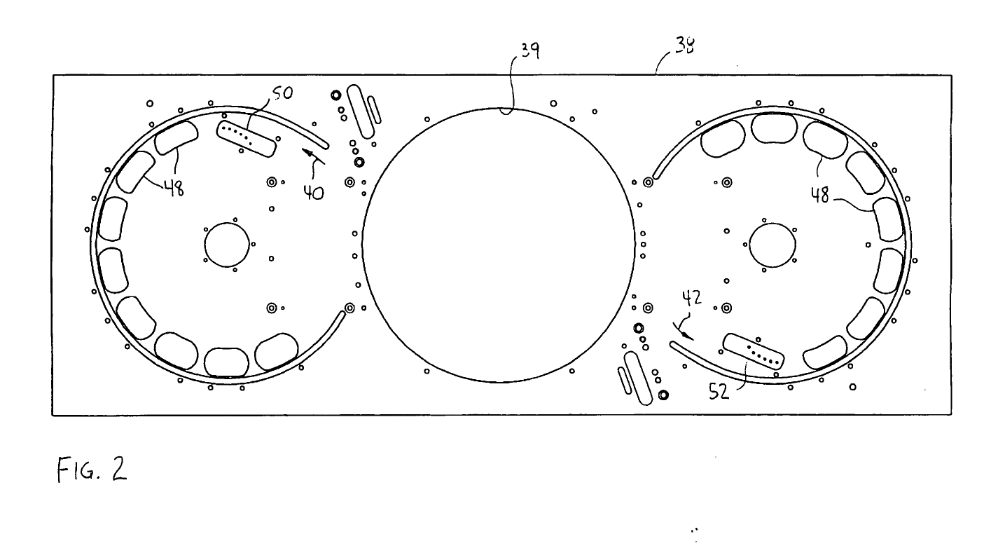

Processing devices 14, 16 share a common stationary plate 38 best seen in FIG. 2. Plate 38 has a central circular opening 39 that receives and surrounds hopper disk 24. Plate 38 receives the two stream of coins from the hopper 12 and includes a first circular coin path 40 associated with coin processing device 14 and a second circular coin path 42 associated with coin processing device 16. Coins travel along coin path 40 in a clockwise direction and travel along coin path 42 in a counterclockwise direction as seen in FIG. 2. As shown in FIG. 1, processing device 14 includes a rotating disk 44 that drives coins along path 40 and processing device 16 includes a rotating disk 46 that drives coins along path 42. Each disk 44, 46 is spaced above plate 38 and is offset from the center of its respective coin path. The coin processing devices 14, 16 are each described in my '067 application and so will not be described in greater detail here.

Illustrated coin processing devices 14, 16 are designed to sort denominations of coins by coin diameter. Each device 14, 16 includes a number of coin slots 48 arranged along respective coin path 40, 42 and extending through the thickness of plate 38. The size and arrangement of the slots in the illustrated embodiment are intended to sort U.S. coin denominations. Sensor arrays 50, 52 upstream of the coin slots in respective coin paths 40, 42 electronically sense and count the denominations of the coins moving along the coin path. Operation of sensor arrays 50, 52 are disclosed in the '067 application and so will not be described here.

Belt drive 18 is associated with coin processing device 14 and drives coins discharged from hopper discharge 30 to coin processing device 14. Belt drive 18 defines a coin path 54 that that is substantially tangential to both the hopper disk 24 and circular coin path 40. Belt drive 18 includes an endless flexible belt 56 whose lower belt run is spaced above and extends along the path 54. The belt run engages the coins and drives the coins along path 54. Construction and operation of the belt drive 18 to drive coins from the hopper to coin processing device 14 is described in my '067 application and so will not be repeated here.

Belt drive 20 is like belt drive 18 and is associated with coin processing device 16. Belt drive 20 includes an endless flexible belt 58 like flexible belt 56 that drives coins discharged from hopper discharge 32 to coin processing device 16. The coins are driven along a coin path 60 that is substantially tangential to both the hopper disk 24 and circular coin path 42.

Coin processing device 10 has two coin processing devices 14, 16 that act simultaneously and in parallel, thereby effectively doubling the speed of the coin processing device shown in my '067 application. Operation of coin processing device 10 is as follows.

Hopper disk 24 is rotating at speed and discharges two single-layer streams of coins from respective hopper discharges 30 and 32. Each stream of coins is accelerated by belt drive 18 or belt drive 20 to space the coins apart as they are delivered to the first coin processing device 14 or second coin processing device 16.

Coins moving along coin path 40 or coin path 42 pass sensor array 50 or sensor array 52 respectively, and the denomination of each coin is sensed electronically. The sensor arrays 50, 52 preferably each sends a signal representing the denomination of the coin passing the array to a central processor (not shown) that accumulates the total number of coins and total value of coins passing through each coin processing device 14, 16 and the coin machine 10 as a whole.

The illustrated coin processing devices 14, 16 sort coins by denomination. In other embodiments coin processing devices 14, 16 can be coin verifiers or some other type of coin processing device.

The illustrated coin machine 10 has a hopper having two discharge openings to feed two coin processing devices. In other embodiments of the invention additional discharge openings and respective drives can be provided to feed additional coin processing devices. If necessary the radius of the hopper disk can be increased to provide sufficient room to fit the additional coin processing devices. The rotational speed of the hopper disk may need to be increased to reliably discharge coins from the additional hopper openings, or a different feed arrangement can be used to form the coin streams.

The illustrated embodiment has separate drive motors for turntable 24 and each of drive disks 44, 46. In other embodiments a common motor can drive two or all three of turntable 24 and disks 44, 46. Belt drives 18, 20 also are provided with separate drive motors, but a common motor can be provided to drive both belts 56, 58.

While I have illustrated and described a preferred embodiment of my invention, it is understood that this is capable of modification, and I therefore do not wish to be limited to the precise details set forth, but desire to avail myself of such changes and alterations as fall within the purview of the following claims.

What I claim as my invention is:

1. A coin receiving and processing machine comprising:
a turntable for receiving coins, a wall extending around the periphery of the turntable, and at least two spaced-apart openings in the wall to discharge coins from each opening;
at least two coin processing devices, each coin processing device associated with a respect opening to process coins discharged from the respective opening and arranged around the turntable;
at least two drives, each drive extending between a respective wall opening and the coin processing device associated with said opening and comprising a drive member configured to engage coins discharged from the wall opening and drive the coins to the coin processing device,
whereby the coin processing devices can simultaneously process coins discharged from the turntable.

2. The coin receiving and processing machine of claim 1 wherein each drive member is an endless belt.

3. The coin receiving and processing machine of claim 1 comprising a singulating plate adjacent each opening.

4. The coin receiving and processing machine of claim 1 wherein the at least two openings consists of two openings essentially 180 degrees apart.

5. The coin receiving and processing machine of claim 1 wherein the openings are equidistantly spaced around the turntable.

6. The coin receiving and processing machine of claim 1 wherein each coin processing device comprises one of: a coin sorter or a coin verifier.

7. The coin receiving and processing machine of claim 1 wherein the at least two coin processing devices comprise a common support surface.

8. The coin receiving and processing machine of claim 7 wherein the turntable is mounted in an opening of said common support surface.

9. The coin receiving and processing machine of claim 1 comprising an accumulator that accumulates the total number or value of coins processed by the machine, and wherein each coin processing device generates a signal representing the presence or denomination of each coin received by the coin processing device and transmits that signal to the accumulator.

10. A coin machine comprising:
a hopper having an intake to receive coins to be processed by the coin machine and configured to simultaneously discharge at least two streams of coins from the coins received at the intake;
two or more coin processing devices, each coin processing device configured to process a respective stream of coins discharged from the hopper; and
means for transferring each stream of coins to the respective coin processing device wherein the coin processing devices process coins in parallel during operation of the machine.

11. The coin machine of claim 10 wherein the hopper includes a rotating support surface that receives coins on the surface.

12. The coin machine of claim 10 wherein the means for transferring comprises a drive member associated with each coin processing device and extending between said coin processing device and the hopper to engage and urge the stream of coins to the coin processing device.

13. The coin machine of claim 10 wherein the drive member comprises a belt run configured to press against the coins driven by the belt run.

14. The coin machine of claim 10 wherein the said at least two coin processing devices comprise a common coin support surface.

15. The coin machine of claim 14 wherein the common coin support surface surrounds the hopper.

16. The coin machine of claim 10 wherein the hopper includes a peripheral wall and the streams of coins are discharged through respective openings in the peripheral wall.

17. The coin machine of claim 10 comprising sensor means for accumulating the total number or total value of coins processed by the coin machine.

18. The coin machine of claim 17 wherein said sensor means comprises means for accumulating the total number or total value of coins processed by each coin processing device of said coin machine.
